(19) United States
(12) Patent Application Publication
(10) Pub. No.: US 2004/0078105 A1
(43) Pub. Date: Apr. 22, 2004

(54) System and method for workflow process management

(76) Inventors: Charles Moon, Round Rock, TX (US); Michael Zrubek, Granger, TX (US)

Correspondence Address: TAYLOR RUSSELL & RUSSELL, P.C., 4807 SPICEWOOD SPRINGS ROAD, BUILDING ONE, SUITE 1200, AUSTIN, TX, 78759, US

(21) Appl. No.: 10/653,457

(22) Filed: Sep. 2, 2003

Related U.S. Application Data
(60) Provisional application No. 60/407,729, filed on Sep. 3, 2002.

(51) Int. Cl. G06F 19/00

(52) U.S. Cl. 700/100

(57) ABSTRACT

Many business processes involve manually controlling and monitoring informational artifacts, such as documents or insurance claims, through a workflow process. The present invention provides a dynamic and flexible method for controlling workflow processes by arranging complex tasks into predefined sequences having decision points that control the process to completion. The method comprises defining procedural components of a process flow model, defining control links for connecting the procedural components, defining data components of a process data model, defining data links for connecting the procedural components and the data components, and invoking the procedural components for producing a workflow process result. The procedural components comprise nodes in the workflow process, which may be automated, interactive or manual procedures. The nodes are connected and executed in a defined sequence determined by control links. The data components comprise data sets connected to procedural components by the data links.

This application claims benefit of U.S. Provisional Application No. 60/407,729, filed on Sep. 3, 2002.

### BACKGROUND

The invention relates generally to electronic workflow processing, and more particularly to software systems and methods for managing a flow of tasks and data involved in a business process. Workflow software enables the user to manage a process by arranging complex tasks into predefined sequences with decision points that steer tasks to completion. The queuing and tracking of tasks is often controlled by middleware called a workflow manager.

Workflow is the controlled processing of artifacts (documents, claims, etc.) as they move through a process. A workflow process may include automated as well as manual process steps or sub-processes. The primary purpose for workflow support is to enhance the usage of products in flexible enterprise solutions. Workflow management controls and monitors document processing according to a defined process model. In addition, multiple common and/or specialized utilities and small applications may be created to perform generic or specific functions to aid in workflow processing. All applications and utilities may be invoked and/or controlled by the workflow manager.

Applications for management of a workflow process according to the present invention include insurance claims evaluation for detection and prevention of insurance fraud, transaction risk detection, identification verification for use in credit card verification and airline passenger screening, records keeping verification, and government list comparisons. Standard plug-in applications for use with the workflow process include similarity search agents for searching disparate databases and reporting search results to the process, a classification engine for classifying transactions or search results, an analytic engine for analyzing results such as biometrics and providing inputs to a decision engine, a rules engine and a report engine. Customer applications may be readily integrated into the workflow process, which include cultural names data, report engines, rules engines, neural networks, decision trees and cluster engines.

In the context of the present invention, workflow is limited in scope to that of processing of an initial artifact such as an insurance claim document or a particular person, and any of its sub-processing or children that may spawn off of it. When thinking of terms of a manufacturing line, the process consists of various operator stations, each station usually contributing to the construction of a final assembly of some kind. Such a process defines the individual steps (nodes), along with their parts (data) that come into a node and leave the node. Such a process defines a ‘composition’ process. In insurance claims processing, the opposite may occur. The process starts with a collection of claims, which may get processed and broken into smaller claims, perhaps representing a ‘decomposition’ process. However, the claim stays as that, a claim, throughout the process, until the process is completed. This process therefore supports a single artifact as it progresses through the process. The disclosed workflow supports this one-artifact process as well as multiple artifacts as a group.

Workflow solutions may incorporate numerous software applications, manual procedures, data sources, and reports that are used to do the work of an enterprise. However, to deploy a workflow solution, some additional facilities are required to organize and control the others. These facilities form the basis of a workflow software product. Because they are involved in the same business process, the tasks in a workflow usually share access to application data in a shared data repository. Ordinarily this is some form of sharable, persistent storage such as a relational database or network filesystem. For example, this would mean storing schemas where all the clients and servers can access them, rather than each maintaining separate duplicate copies.

A workflow controller is a supervisory program that is responsible for accepting new jobs, moving jobs from station to station, monitoring progress, and reporting results. At one extreme, this can be a simple tracking system. At the other, it can be a full-blown transaction monitor. The tough issues facing a workflow controller are concerned with task synchronization and error recovery. Queue management and load balancing can be handled by a workflow controller or by external software. A job can exit the system when it completes, when it aborts, or when an exception occurs.

Workflow definition is performed by a workflow modeling facility, often with a strong graphical component, that allows the implementer to define a workflow. The workflow is laid out as a sequence of branching (and sometimes looping) tasks connected by decision points. Decision points route the flow of work according to predefined business rules. Oftentimes, these rules are automated and interface with decision support facilities. Nodes represent the tasks to be performed. Some may be fully automated (“batch” mode) and others may require user attention (“interactive” mode).

### SUMMARY

The present software system and method is a workflow manager that controls all aspects of a workflow process. It may be configured in a direct component configuration or in a flexible services network configuration. The workflow manager controls movement of artifacts and data through a predefined process. Workflow process models define definitions of processes and data used within the processes. Each process has a unique process model that is a map or definition of the steps performed within the process. Various modeling components are assembled to construct process models.

The process models, according to the present invention, comprise a process flow model and a data model. The process flow model consists of procedural steps while the data model defines data structure and transitions that occur to the data from a data set perspective.

Table 1 provides definitions used to describe workflow components and models.

TABLE 1

| Term | Description |
|---|---|
| Artifact | A primary object, such as a claim or document, that ‘moves’ through a |
| | process. These are the subjects that are managed by the workflow |
| | system. |
| Process Model | A modular representation of operational steps and supporting data. |
| Process Flow | Representation of the physical operational steps that define a process |
| Model | excluding all data. Models consist of Nodes, Decisions, and Control |
| | Links. |
| Data Model | Representation of data definitions in a Process Model. Data Models |
| | consist of Data Sets, Data Links, and supporting components. |
| Nodes | Activities, service providers, sub-processes, or applications that |
| | perform tasks. Examples are a Classification Engine and utility |
| | applications. |
| Node Group | A collection of identical nodes, represented as a single node in the |
| | process model. A Node Group is used to define a list of same- |
| | functionality nodes whose individual use or availability is dynamic. |
| | This supports a notion of scalability, workload balancing, redundancy, |
| | and fail-over by defining a node as an abstract service within a group, |
| | with a specific node being determined and invoked during processing. |
| Flow Control | A special, internal Workflow node for specialized process routing. |
| Node | Used for process splitting and process joining. |
| Decision | These provide logical evaluation of results and data to determine |
| | process navigation or progression. Various rules are used here to infer |
| | navigation and routing using complex, dynamic decisions. May be |
| | referred to as Transition Conditions |
| Control Link | Connects components to other components, establishing navigational |
| | processing paths. |
| Data Set | Defines workflow-level data, including input and output data |
| | specifications for nodes. |
| Data Link | Connects Data Sets to various components, data sources, and data |
| | sinks. Identifies sources and targets (sinks) of workflow-level data |
| | flows. |
| Data | Data-oriented processing nodes or activities in the Process Flow |
| Transformation | Model, used to perform alterations on Data Sets. Examples include |
| | data mapping conversions, data joining (merging of Data Sets), and |
| | data splitting (splitting a Data Set into multiple Data Sets). |

An embodiment of the present invention is a software implemented method in a computer system for controlling and monitoring a workflow process by arranging complex tasks into predefined sequences according to the workflow process, the method comprising the steps of defining procedural components of a process flow model, defining control links for connecting the procedural components of the process flow model, defining data components of a process data model, defining data links for connecting the procedural components of the process flow model and the data components of the process data model, and invoking the procedural components for producing a workflow process result. The step of defining procedural components of a process flow model may comprise the steps of specifying nodes for identifying automated applications, services, function process steps and manual process steps of the workflow process, specifying node groups for containing multiple active nodes, specifying decision nodes for evaluating data and making flow control routing decisions in the workflow process, specifying data transformations for altering data sets, and specifying flow control nodes for splitting one process path into multiple process subpaths and joining multiple process subpaths into a single process path in the workflow process. The manual process steps may comprise interactive nodes. The step of invoking the procedural components may comprise the steps of initializing node processing and setting node counter N=0, invoking node N and updating node status, performing node N processing, updating node N process table, obtaining node N output data, evaluating node N results by decisions and rules, determining if all nodes are invoked, if all nodes are not invoked, letting N=N+1 and repeating the steps above beginning at the step of invoking, and if all nodes are invoked, ending the method. The step of defining data components of a process data model may comprise the steps of specifying data sets and data with a format specification, specifying a source of the data, and. The step of specifying data sets may comprise the steps of specifying input data, specifying output data, and specifying a processing node. The method may further comprise defining the workflow process, the procedural components, the control links, the data components and the data links as XML files. The method may further comprise the step of storing the process flow model, the control links, the process data model and the data links in a workflow database as workflow process configuration tables. The method may further comprise the step of defining the workflow process as a root element, comprising the steps of specifying unique identification and name attributes of a workflow process, specifying message attributes including enter process message, exit process message and exit error message, specifying an optional description of the workflow process, and specifying workflow process child component elements. The method may further comprise the step of specifying nodes as child component elements, comprising the steps of designating unique identification and name attributes of a node component, designating node attributes, including application type, return type, wait type, timeout, number of retries, interval between retries, and maximum number of concurrent executions, designating a node group that the node belongs to, designating a command for executing the nodes services and any parameters used when executing the node, designating service level definitions including identification, name and start type, designating start command and associated parameters, and designating security parameters including connection type and resource, URL, user identification and password. The method may further comprise the step of specifying node groups as child component elements, comprising the steps of designating unique identification and name attributes of a node group component, designating node group attributes, including application type, return type, wait type, timeout, number of retries, interval between retries, and maximum number of concurrent executions, designating a node group strategy attribute for determining a node selection strategy, designating a node group that the node group component belongs to, designating a command for executing the nodes services and any parameters used when executing the node, designating service definitions including identification, name and start type, designating start command and associated parameters, and designating security parameters including connection type and resource, URL, user identification and password. The method may further comprise the step of defining control links as child component elements, comprising the steps of designating unique identification and name attributes of a control link component, designating control link attributes, including link type for defining the type of component that is pointed to by the source, required for designating process flow joins, and optional integer value for defining the control link, designating a source identification for defining a component where a process flow is coming from, designating a target identification for defining a component where a process flow is going to, and designating a reference identification for an optional object reference for the control link. The method may further comprise the step of specifying decision nodes as child component elements, comprising the steps of designating unique identification and name attributes of a decision node component, designating decision node attributes, including decision node control type for indicating support for single or multiple control paths, condition evaluation functions for directing control path upon successful evaluation of the condition, data identification for indicating a source of a specific data set, and an optional salience value for determining a priority of processing of the condition, designating an onok when a return code is 0, an onerror function when an error is produced, an ondata function when evaluating a data item with a specific value, an onexists function for checking to see if data exists for a given name, and an oncompare function for comparing two values that may be strings or numbers, and designating a rule function for specific rule evaluation and a default function for defining default routing. The method may further comprise the step of specifying data sets as child component elements, comprising the steps of designating unique identification and name attributes of a data set component, designating data set attributes, including source identifiers for identifying a source of data, type for explicitly defining where the data comes from, source name and object identification for defining source characteristics, and designating a data format definition for defining a format of the data in the source and a data attribute for defining an expected data structure. The method may further comprise the step of defining data links as child component elements, comprising the steps of designating unique identification and name attributes of a data link component designating data link attributes, including link type for defining how a data set is linked to a component, usage type for indicating if a component is a source or sink for data, and required for indicating if data is required before process flow can continue, and designating data set identification for containing data, and target identification for identifying a component for linking to the data set. The method may further comprise the step of specifying data transformations as child component elements, comprising the steps of designating unique identification and name attributes of a data transformation component, and type for defining a type of data transformation, and designating data transformation elements, including sources for identifying data set sources for the data transformation, data set targets for identifying target data sets for the data transformation, and mappings for mapping a specific value from a source data set to an element in a target data set. The invention may further comprise a computer-readable medium containing instructions for controlling a computer system according to the method described above.

Another embodiment of the present invention is a software implemented system in a computer for controlling and monitoring a workflow process by arranging complex tasks into predefined sequences according to the workflow process, the system comprising means for defining procedural components of a process flow model, means for defining control links for connecting the procedural components of the process flow model, means for defining data components of a process data model, means for defining data links for connecting the procedural components of the process flow model and the data components of the process data model, and means for invoking the procedural components for producing a workflow process result. The means for defining procedural components of a process flow model may comprise nodes for identifying automated applications, services, function process steps and manual process steps of the workflow process, node groups for containing multiple active nodes, decision nodes for evaluating data and making flow control routing decisions in the workflow process, and flow control nodes for splitting one process path into multiple process subpaths and joining multiple process subpaths into a single process path in the workflow process. The means for defining data components of a process data model may comprise data sets and data with a format specification, a source of the data, and data transformations for inputting one or more data sets and for outputting one or more data sets. The means for defining control links may comprise a designation of a source component for defining where process flow is coming from, and a designation of a target component for defining where a process flow is going to. The means for defining data links may comprise a designation of a data set as a source and sink for data, and a designation of a target component for linking to the data set. The means for invoking the procedural components may comprise a workflow manager and a workflow database. The system may further comprise custom application nodes, server application nodes and user application nodes.

Yet another embodiment of the present invention is a software implemented system in a computer for controlling and monitoring a workflow process comprising one or more workflow managers for controlling and invoking procedural components of the workflow process, a workflow database connected to the one or more workflow managers for persisting workflow process tables and configuration tables, including nodes, decisions, control links, data sets and data links, the procedural components of the workflow process including nodes, node groups, decision nodes and flow control nodes, and the procedural component nodes including workflow user applications, automated applications, services, function process steps and manual process steps. The one or more workflow managers and the procedural components may be interconnected by a dynamic services network, whereby the one or more workflow managers make requests for procedural component execution via a network queue controlled by a workflow monitor/administrator.

### BRIEF DESCRIPTION OF THE DRAWINGS

These and other features, aspects and advantages of the present invention will become better understood with regard to the following description, appended claims, and accompanying drawings wherein:

FIG. 1 shows an example of workflow comprising processing nodes, decision points, control links, data sets and data links;

FIG. 2 shows a simplified workflow architecture connected in a direct component configuration;

FIG. 3 shows a simplified workflow architecture connected in a flexible services network configuration;

FIG. 4 shows relationships between a workflow manager and application nodes;

FIG. 5 shows a flow diagram of the steps performed by the workflow manager shown in FIG. 4 to execute a node.

FIG. 6 shows an example of a detailed process model structure for illustrating components of a process flow model and data model;

FIGS. 7A-7G show examples of XML data set data specifications;

FIG. 8 depicts a workflow for a materials order routing;

FIG. 9A shows a partial WORKFLOW_MODEL definition to illustrate common attributes that may be defined in any component;

FIG. 9B shows a WORKFLOW_MODEL definition;

FIG. 10 shows a NODE definition;

FIG. 11 shows a NODEGRUOP definition;

FIG. 12 shows a CONTROLLINK definition;

FIG. 13 shows a DECISION definition;

FIG. 14 shows a DATASET definition;

FIG. 15 shows a DATALINK definition; and

FIGS. 16A and 16B show DATATRANSFORM definitions.

### DETAILED DESCRIPTION OF THE DRAWINGS

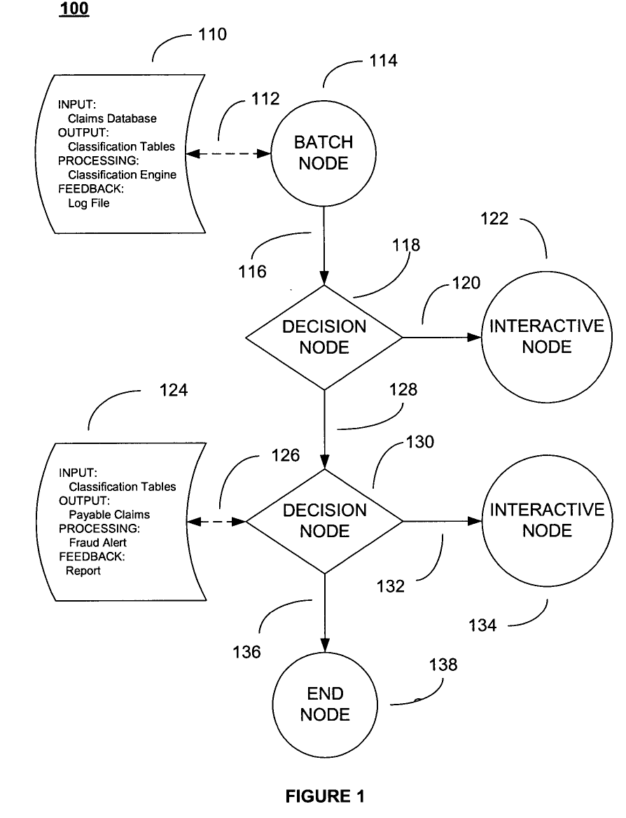

Turning now to FIG. 1, FIG. 1 shows an example of workflow 100 comprising processing nodes 114, 138, decision nodes 118, 130, control links 116, 120, 128, 132, 136, data sets 110, 124, and data links 112, 126. The workflow 100 described in FIG. 1 is a method for processing artifacts or documents through a defined process flow 100 under the control of a supervisory workflow manager. The distinguishing characteristics of this invention are its suitability for flexible, dynamic services networks or federations, its support for data-centric components and controls, and its provision for strong, rules-based decision nodes. An exemplary application of this invention is the management of complex document classification procedures involving external searches of distributed datasources. The workflow 100 shown in FIG. 1 depicts a batch node 114 processing a data set 110 via a data link 112 and connecting to a decision node 118 via a control link 116. The decision node 118 communicates with an interactive node 122 via a control link 120 and with another decision node 130 via a control link 128. The decision node 130 processes a data set 124 via a data link 126 and communicates with an interactive node 134 via control link 132 and with end node 138 via control link 136.

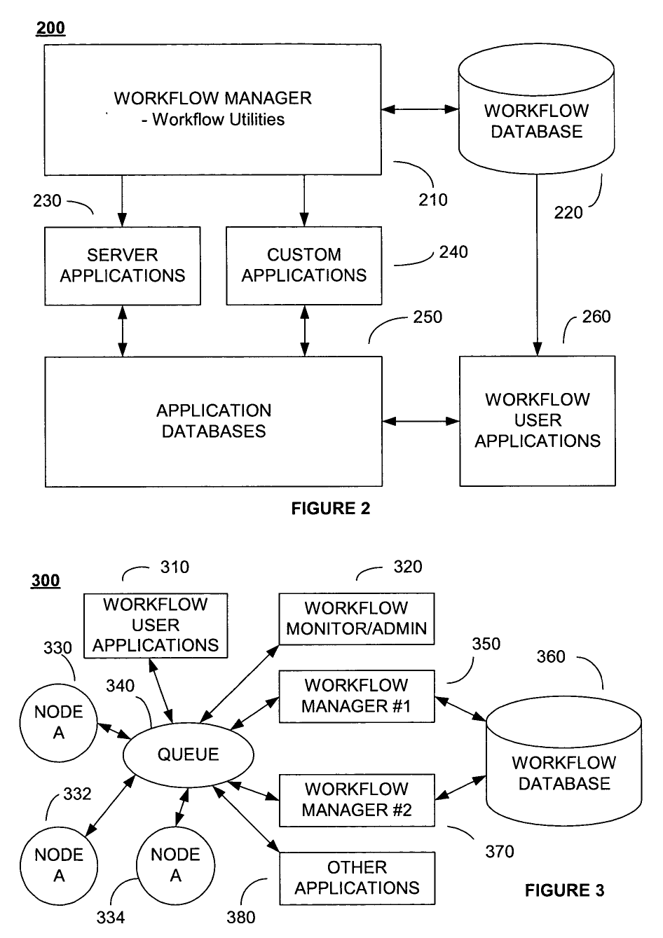

Turning now to FIG. 2, FIG. 2 shows a simplified workflow architecture connected in a direct component configuration 200. A second alternative network architecture is depicted in FIG. 3. Various components communicate or connect together using explicit connections and configuration information. At the heart of workflow is the workflow manager 210 that connects to a workflow database 220, server applications 230 and custom applications 240. The workflow manager 210 controls all aspects of the workflow process. It contains and uses various internal workflow utilities, such as a task scheduler and data filter, and uses the workflow database 220 to track processing and to store workflow-related data. The workflow manager 210 calls other applications 230, 240 as nodes, as defined in a process flow model and exemplified in FIG. 1. Workflow user applications 260 use the data from the applications database 250 and workflow database 220 to support user-oriented activities, such as task list presentation and processing.

Turning to FIG. 3, FIG. 3 shows a simplified workflow architecture connected in a flexible services network configuration 300. Although the explicit configuration of a workflow process shown in FIG. 2 is practical and usable, performance and scalability can be achieved most easily by using a flexible, dynamic services network 300 (also referred to as a “Federation”) as depicted in FIG. 3. One or more workflow managers 350, 370 are connected to the network and invoke services needed via the network. In this configuration, instead of calling an explicit computer or node, a workflow manager makes a request to a service node 330, 332, 334, using a queue 340 and other resources in the network 300, which routes the request to an available node, performs the request, and returns the result back to workflow manager 350, 370. The workflow manager 350, 370 defines and uses nodes 330, 332, 334 as virtual services, and a network controller determines actual available services dynamically. In addition to making use of dynamic nodes, the entire workflow system itself can be replicated and appear as different workflow management applications on the network 300. Each workflow manager 350, 370 may share a common workflow database 360. A workflow monitor 320 is used to monitor and manage the various network systems and applications.

The flexible services network 300 may consist of workflow management applications 350, 370 and workflow user applications 310. The primary workflow application is the workflow manager 350, 370, which controls the overall workflow process actions. The workflow manager 350, 370 controls an artifact and its data through a specified process model, keeping track of progress along the way. The workflow manager functions as a command server. It accepts various workflow commands to invoke workflow processes and to return the status of current workflow processes. In a system component configuration model, this application acts as a pure command server, directly invoking nodes as needed. In the services network architecture 300, it becomes a workflow service node, communicating to other components through the network “Federation”. Several other workflow utility applications are provided for various utilitarian functions. Utilities include workflow scheduling, data cleanup, data importing and exporting, batch processing, and various process and data management tools. Another utility is a workflow monitor 320 that monitors specific events, actions, or data from a node, indicating completion or status. Workflow user applications 310 are applications that make use of workflow results. The primary application is a user task application, which presents a list of tasks or artifacts for a user to process. The workflow management applications 350, 370 create and manage these tasks per process model definitions. This application also enables users to interface with workflow artifacts. This application may comprise a browser user interface, using a back-end server for connection and task support. A user would need to properly authenticate with the server application and be presented with a list of tasks. This requires a centralized storage location for all user-related tasks. Additional user applications 380 include any application that uses workflow data or results, or any user application that is a node in a process model.

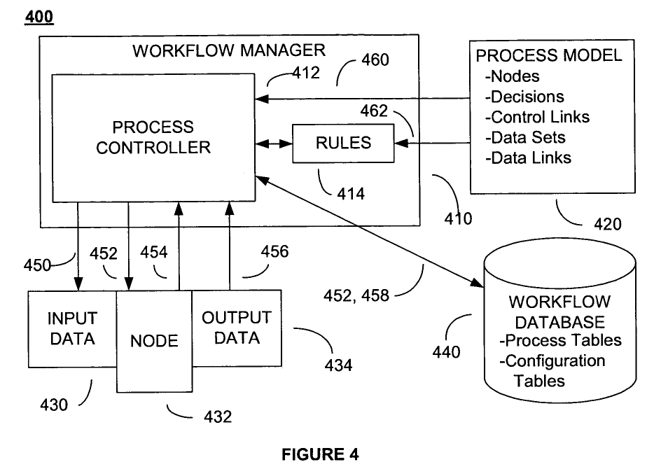

Turning to FIG. 4, FIG. 4 shows relationships 400 between a workflow manager 410, application nodes 432, a process model 420 and a workflow database 440. The workflow manager 410 controls a workflow process by invoking application nodes 432. The nodes 432, along with input data 430 and output data 434, are defined in the process model 420. The process model 420 comprises nodes, decisions, control links, data sets and data links, as depicted in FIG. 1. Decisions from the process model 420 are applied to rules 414 that are used by the workflow manager process controller 412. A typical node processing includes:

preparing input data for a node;

executing the node;

handling output from a node;

making decisions on what to do next and proceed to the next node; and

repeating the steps above.

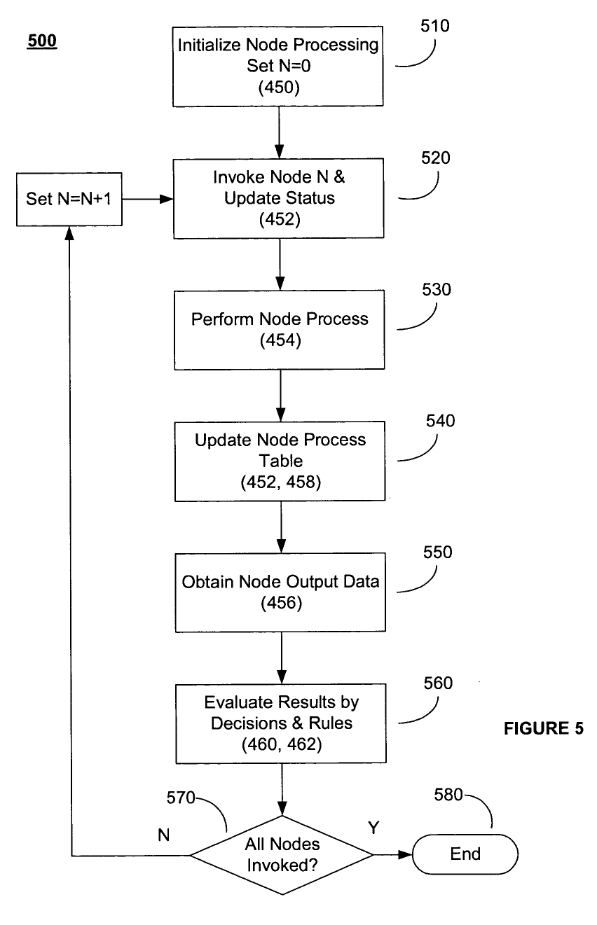

FIG. 5 is a flow diagram that depicts the steps of workflow node processing by the workflow manager 410.

The workflow manager 410 uses various database tables 440 to persist its running condition so that it can be restarted and resume where it may have been halted and to log completed processes and actions. Optionally, persistence of selected process data may be supported, providing a means to store data collected or created within a workflow process. Such data could be needed for justification purposes or for data input into other systems' databases. Persisted data includes process database tables and process model configuration tables stored in a workflow database 440.

Workflow process management information is persisted in process database tables 440. The status of every active process is maintained in an active process database table. As processes complete, they are moved to a completion table or log. By using such a single table for active processes, any workflow manager can manage any of the processes in the table and determine the status of a process. Reports may also be created to capture the current processing state of the overall process. The contents of this table are primarily intended to support the workflow management. However, a few additional columns are used to provide support for reporting and informational messaging needs. Additional tables exist for component execution logging, processes that have completed, and temporary data set data storage. In addition, a table is used to manage the workflow process IDs. Each executed process (each workflow request) is identified by a unique workflow process ID. This ID is generated from within Workflow, using a database table to function as an ID generator.

An object-based representation of the workflow process model 420 (nodes, control links, decisions, etc.) is used and is stored in a set of database tables as process model configuration tables 440. If database persistence is not used, each workflow process model is defined in its own XML model file. The concepts of nodes, control links and decision points (or just decisions) are unique to workflow, and therefore, complete definition and support of these components is required. Note that by using a well-constructed process and data model structure, graphical representation and manipulation of that model can be accomplished in a user interface application.

Regarding workflow node execution and operational integrity, a workflow manager would typically manage an entire process by creating an entry in workflow database tables before executing a node, calling the node via XML (or similar interface), waiting for a response, and updating the status data in the table when the node completes. A workflow manager needs to keep a more detailed track of where it actually is in a process. For example, in addition to logging node entry and exits, a workflow manager may log entry and exit of other components, such as control links. If a workflow unexpectedly halted, it could then resume exactly where it left off. In an architectural sense, each node should have a set of workflow interface methods to easily integrate into workflow. One method would be to update the workflow process status, which may be a service on a network ring, with queuing of the status requests to the ring as nodes set their status. The status can then be updated in the workflow table. Such a process could also reside within a workflow application, so that it gets status update requests, stores them, and then uses that to move to the next process as needed. The workflow manager may also control the actual status management. A called application or node component must respond/reply to its caller, either when done or periodically with status. A return code result as an XML response is a preferred response to the workflow manager when a node completes its requested task.

Regarding workflow communications and interfaces, the workflow manager and other workflow applications (including utilities) need to communicate with other nodes and/or services. Communications includes invocation of applications and the handling of response data. Applications can be invoked through various means, and results can be returned to a workflow manager in different ways. However, to provide a set of reasonable interface specifications, only certain types of application invocation methods are supported. Responses must conform to recognizable formats. The workflow manager communicates with current XML-driven command processors and servers. Therefore, the workflow manager is a command server application with appropriate command handlers. Communications with applications is supported though a command server implementation. Each application is an instance of or derivative of (extends) a BaseCommandServer class. The workflow manager sends XML commands to the server application, the application processes the command, and an XML response is returned to the caller of the workflow manager application. Communications with other applications, such as binary executables, explicit Java classes, and remote URL services (true web services), are also supported. Communications within nodes that exist in the Federation or in a Services Network Ring is dependent on Federation interface specifications. This interface is a command-oriented interface, similar or identical to the application server interface.

Turning to FIG. 5, FIG. 5 shows a flow diagram 500 of the steps performed by the workflow manager to execute a node, as shown in FIG. 4. The workflow manager initializes the processing of a node 510, based on a process model (see 450 in FIG. 4). The workflow manager then invokes the node 520 by launching the node, issuing XML commands, etc. according to the node definition (see 452 in FIG. 4). The workflow manager also updates the status in a process table indicating that the node has been started. The node then processes 530, notifying the workflow manager on completion (see 454 in FIG. 4). The workflow manager then updates a process table as needed to reflect the process status 540 (see 452, 458 in FIG. 4). The workflow manager obtains the node output data or results 550 (see 456 in FIG. 4). The workflow manager evaluates the status/results and the output data 560 (see 460, 462 in FIG. 4), and uses decisions and rules to determine whether to iterate the process 570 or to halt execution 580.

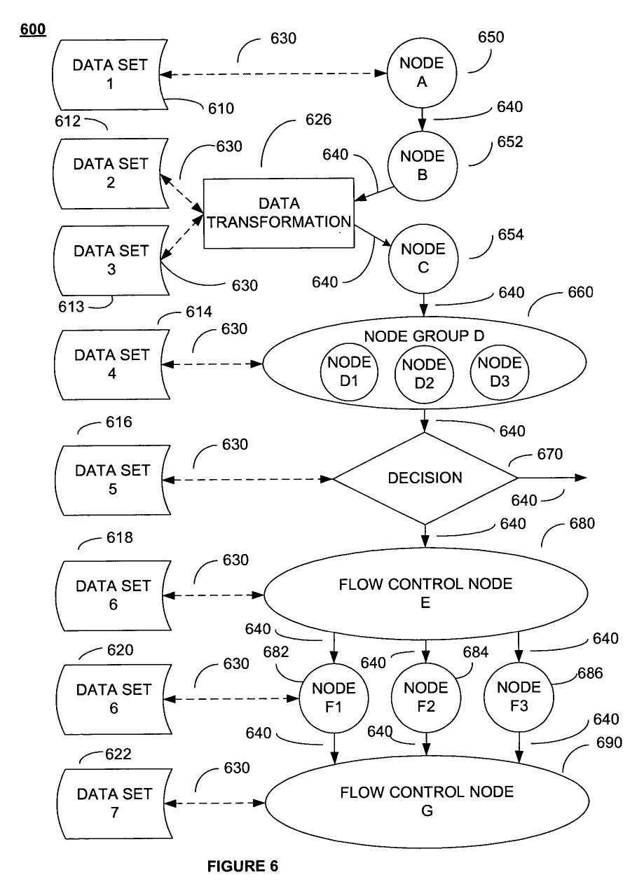

Turning to FIG. 6, FIG. 6 shows an example of a detailed process model structure 600 for illustrating components of a process flow model and data model. Process models consist of two parts, a process flow model and a data model. The process flow model defines the procedural steps to follow, including decision points and logic. The objective of the flow model is to define all possible navigational paths in the process. There is a single complete flow model, although it may contain sub-processes within it. The data model defines data and the transitions that occur to the data, where each set of data is contained within its own “data process”. The data model defines a process from point of view of a set of data. Multiple data processes can exist in a workflow process model. Data processes may be simple, single pieces of data contained in a data set, or a data process may be a collection of data sets connected together with joins and/or data transformation operations to provide a multi-step data-centric process. The mechanism connecting a flow model to a data model comprises data links 630. Data links 630 identify the source of a set of data and the target or sink for that data. Typical sources include databases, command line parameters, process data, output from a node or other component, and other data sets. Typical targets include nodes or other model components, other data sets, process data, and databases. Data links 630 connect the pieces of data in the data model to points of creation and usage in the flow model.

Regarding a process flow model, a process flow model defines the navigational paths of execution for a process. If contains various components that define the process flow (control links 640) and specific points of operational activity (nodes and decisions). Process flow models may be a simple one-path process or a complex structure of parallel paths and imbedded processes. When defining a flow model, all possible states of execution and navigation must be accounted for, especially in regards to error conditions.

A node 650-654, 682-686 defines an application, service, or function that is callable by a workflow manager. A node 650-654, 682-686 may also represent manual process steps, with explicit input/output data and entry/exit conditions. In a flow model, a node 650-654, 682-686 represents a “black box” of functionality. The process leads into the node 650-654, 682-686, and expects some response or result upon its completion. Functionality within a node 650-654, 682-686 is of no concern to workflow manager. Node definitions must define the connectivity specification to access the node and how the node is to be invoked. A node 650-654, 682-686 may be invoked via an XML command, as a direct Java class load and call, or by other methods. Invocation for some of these can be done either synchronously or asynchronously, while some calling methods may only support synchronous execution. Also, node definitions must define expected input parameters. A node Group 660 is simply a container with multiple active nodes. The purpose of a node group 660 is to allow a process to use a node group 660 in place of a specific node whenever the actual node that is used may vary. For example, in a system with three of the same nodes that perform the same functionality, and there are three of them for load balancing reasons, a node group 660 could be used to represent that group of three Nodes. However, only one physical node within a node group 660 will be used for an executing process. The choice or assignment of which node is used is dependent on the node group's configuration. Assignment may be based on a round-robin approach, first available, current processing loads of each node (the number of requests each is processing), or custom rule or decision processing. When a node within a node group 660 is defined, it must define the node group 660 it is a part of. The node group 660 is responsible for initializing, invoking, and running specific nodes, based on their availability and on assignment settings. The list of available nodes within a node group or within a workflow process may dynamically change.

Decisions 670 evaluate data and make flow control routing decisions. Decisions 670 may use a flow control node 680, 690 to split a process into separate processes. If a single process path is to be taken, the decision 670 would determine that single path, based on its settings and evaluation rules. Decisions may also be used at a data level to decide what data to use or pass on to the rest of the process. While the process flow would be the same, the actual data would change. The data model would have to identify the possible data sets 610-622. Decisions are navigated to and from with control links 640. One control link 640 enters a decision 670, and one or more control links 640 leave it. Each exiting control link 640 has a condition or a set of conditions associated with it that cause that control link 640 to be used. The configuration of decisions 670 define whether multiple exit paths are possible or if only one is possible. When defining a process flow, a default path must be defined to leave a decision 670. Otherwise a dead path condition may occur, where operational flow ends at the decision 670. This default path is followed when all other paths are rejected. In addition, if only one exit path exists, such as when a model is not complete and a decision 670 is just a placeholder for future flow paths, the default path would be the single exit path. Evaluating data within data sets 610-622 from data links 630 and prior operation result data in the input control link 640 determine flow routing within decisions. Several simple, predefined evaluation functions are supported. These include use the result code in the control link and route differently if error or no error, route differently for different error codes, use common result data from the previous node (including score, count and result message strings), and use a combination of the above in a formula. In addition to the above, complex decisions can be performed by using rules.

Decision rules define custom decision evaluations. Common rule syntax is used to define a rule. Rules are used in decisions 670 to make process flow and data routing decisions. Inputs are data sets that link into the decision 670, along with the incoming control link data. When rules execute, their output operation is typically selection of a control link 640 for process routing and operations on data. Rule execution in a decision 670 is configurable to allow multiple rule execution or only a single execution, represented by multiple possible exit paths from a decision or only one allowable exit path.

Control links 640 define explicit paths of navigation or progression in a process. Control links 640 connect one component to another and indicate beginning and ending points in the process flow. The following restrictions apply to control links 640:

each control link 640 defines a single path;

only one control link 640 can exit a node or node group;

only one control link 640 can enter a decision 670, but multiple control links 640 can leave a decision 670;

control links 640 must point towards a flow control node 680, 690 if process flow is to be split or joined;

defining parallel control links 640 leaving a flow control node 680, 690 supports parallel paths; and

process beginning and ending points are defined by control links 640.

A control link 640 contains a source that is the component that the link is leaving from, and a target that is the component that the link is going to. For beginning points, there is only a target with no source. For ending points, there is only a source with no target.

A flow control node 680, 690 is a special workflow node that either causes a process to split into multiple processes or causes parallel processes to join into one process. This node is not a decision mechanism, but it provides simple process convergence and divergence functions. For splitting a process, one control link 640 enters a flow control node 680, 690, and multiple control links 640 leave the flow control node 680, 690. The determination as to which control links 640 to invoke on the output is defined in each control link 640 and in the flow control node configuration. For joining multiple processes into one path, multiple control links 640 enter a flow control node 680, 690 and only one leaves the flow control node. Process joining requires resolution of timing issues and dead path handling. The configuration of a flow control node 680, 690 and control link settings define how the process is to wait and handle latent parallel processes.

The data model describes the various pieces of data used or controlled by a workflow. Each piece of data is described in a data set 610-622. Data sets 610-622 may pass through data transformation operations 626 that convert, map, break apart, or assemble various data elements from one or more data sets 610-622. Data links 630 connect data sets 610-622 to other data sets 610-622 or components. The data components and the interconnections are defined in the data model. This data model describes what the pieces of data are and where they come from. The data model does not describe nor indicate uses of data by process flow model components. The data model is like a large schema for all relevant workflow data, including data structure definitions. The data model defines static data definition components for the overall workflow process model. These data definitions contain no run-time process-specific data. They only provide a static definition of what data is to be provided by a data set 610-622 when it is used. During run-time processing, where workflow is executing a process, actual instances of data sets 610-622 will contain data pertinent to the specific process. These instances are derived from the data model data set definitions and are then filled with their data as needed.

Data links 630 connect data sets 610-622 with components that use or produce data set data. In the process flow model, data links 630 connect data sets 610-622 to flow model components. While the data sets 610-622 define the contents of its data, data links 630 define usage details. Since each usage or production of actual data may vary by component, the data link 630 defines usage characteristics for that data, including required or not required, if it is input data, get it before proceeding and if it is required, and fail on error or continue if the data cannot be read or written. The data link 630 identifies a source and target. When reading from a data set 610-622, the data set 610-622 is the source. When storing into a data set 610-622, the data set is the target.

Data sets 610-622 represent a collection or set of data with a format specification. The data format is defined in an XML manner. The format defines the structure and expected names of values of the data that exists in a data set 610-622 when it has data. Data sets 610-622 also define the source of their data. The source of the data is used to obtain the actual data values during run-time processing. The following are sources of data:

a schema to identify data read from a database, the schema including the database, table, and data to be read;

extracted from the results of a workflow XML command;

node/component output from XML command responses or returned string results data from other data sets or from data transformations;

using pre-defined workflow or constant data values, such as a Run ID, etc.; and

custom Java objects that provide data values.

The data set configuration defines the format and source of data, along with any accessing specifications. Data set data must be provided in a consistent format. Two levels of consistency are required. One is at the data specification level, and the other is at an internal application usage level.

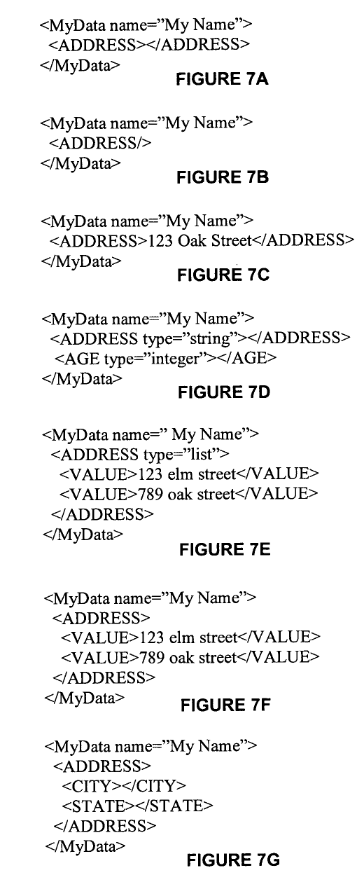

Turning to FIGS. 7A-7G, FIGS. 7A-7G show examples of XML data set data specifications. Data set data specifications define the data contents in an XML format. Since the actual data values, except for constant values, are obtained during run-time, element placeholders must exist for the various data values. Simple XML tag definitions marking the beginning and end of a location are sufficient, and they may be attribute-level or element-level values. Variable data is defined to exist in element values, and constant values are defined in either attributes or elements. In the data set data specification shown in FIG. 7A, the value for ADDRESS would be obtained during run-time, while the name attribute is constant. The result of such structure allows for any set of data to be represented as a collection of values. Whether they are elements or attributes is usually irrelevant, since users of the data just need to know the names of the values. The definition shown in FIG. 7A may be defined as shown in FIG. 7B. However, if the equivalent XML for storage is extracted with existing data, the format shown in FIG. 7B will be used as needed to include the data within the XML, as shown in FIG. 7C. Elements may define their data type explicitly, which may be more compatible with other XML-based systems. Valid types are “integer”, “float”, and “string”. If no type is given, a string is assumed. See FIG. 7D for an example of a string type. Specific data elements may exist as a list, as shown in FIG. 7E. Although the ‘type=“list”’ is optional, such a specification shows that ADDRESS can contain multiple values. By default parsing conventions, the existence of XML within an element indicates one or more sub-element values. FIG. 7F is an example of an XML data set data specification that defines two items in the ADDRESS list, both named VALUE. For internal data set usage, workflow applications access the various data values in a consistent manner. This is particularly important for rules, because data must be accessible in a named as an object-attribute pair. Workflow applications access specific data values from a data set by the value's name. Values are returned according to their element type definition. If no element type is defined, “string” is used as the default type. Hierarchical data often exists in XML, such that an element is nested within another element. FIG. 7G shows an example where CITY resides within ADDRESS. In such cases, the name for an element must be provided as a complete X-Path. For example, to get the CITY value, “MyData/ADDRESS/CITY” would be used as the name of the value.

Turning back to FIG. 6, a data transformation 626 is a special, data-oriented operational node that performs some transformation function on a set of data. The node operates at the data level and is part of the process flow. Input is one or more data sets 612, 614, and output is one or more data sets. The actual data operation that occurs is dependent on the implementation of the node. Each transformation node 626 defines a set of specific internal, pre-defined transformation methods or specifies a custom processing class or program to invoke. Typical methods are schema mappings, data set merging, and data set splitting.

The connections between a process flow model and data model are provided exclusively by data links 630. For flow model components, data links 630 identify the data inputs and outputs for a component such as a node. The actual data specification is defined in data sets 610-622. When used in a flow model, data links 630 always connect to a data set 610-622 on one end and a flow model component on the other end. This linkage defines either a single data input source to a component or a data sink for component output. Multiple data links 630 are used to identify the use of multiple data sets 610-622, with each data link 630 pointing to one data set. For component inputs, data sets 610-622 define pre-requisite database data that is needed or input parameter data for a node. Although input parameters are typically defined as part of a node's definition, values can be obtained from data sets 610-622. Data links 630 also define the output data available from a component, either as database data or message-oriented data, such as XML result text. Using data sets 610-622 linked with data links 630, the entire data I/O for a component may be specified. This data is available for other components and for workflow process flow rule evaluations.

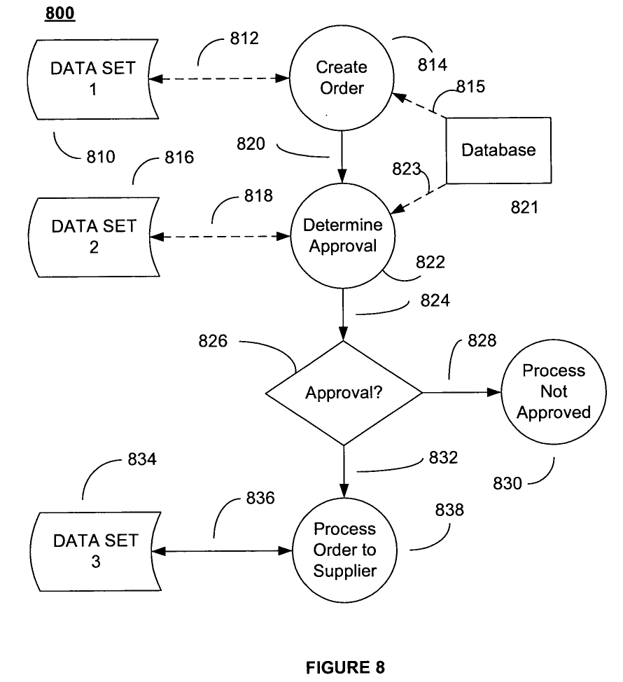

Turning to FIG. 8, FIG. 8 depicts a workflow for a materials order routing. This example illustrates a clarification that must be made between application-level data and data that is provided by workflow in data sets 610-622. Application-level data is data that node applications use to perform their task. Multiple applications in a process may use the same underlying data. For example, in a process for order routing shown in FIG. 8, one application may create an order 814 using other tables 821 to fill in parts of the order, such as the prices, customer information, and billing terms. The order is then routed 820 to another application for approval 822. This application looks at the order contents, looks up the customer's account standing 821 recommends or denies credit. The order is then routed 824 to a decision 826, where it is marked as approved or rejected. If the order is rejected, the order is routed 828 to a node for processing not approved orders 830. If the order is approved, the order is routed 832 to a final application completes processing of the order 838, either sending it out to the suppliers or sending it to someone via internal e-mail. In this example, the underlying set of data for the order always resides in the database 821. As each application performs it's processing, it just needs to know the identity of the order in which database where it resides. The application gets the pertinent order data details and performs its processing on the order. Workflow would support the above as follows. Workflow would invoke the node for the initial application to create the order 814. When complete, the node returns 812 the internal order number to workflow as result data in a result data set 810. Only the order number is needed by workflow for continued processing, not the entire order contents. Workflow would then invoke a second application node to determine an approval status 822, passing it the order number 818. This node would return a status to workflow indicating success or failure. Workflow could evaluate the result with a decision 826 and make a routing decision and call the proper node application 830, or it could simply call the final application node 838 and complete the order processing. As described above, application-level data remains at the application level, while workflow uses a minimum piece of data, such as an order number to “move” the order through the process. Workflow does not require the entire contents of the order. Node applications know what data it uses and requires. Much of the data will be located in one or more databases and tables. While workflow could provide all possible data to each node, this is required. It is the application's responsibility to get what it needs and to store what it needs, from the appropriate locations. Workflow can provide the database connection definitions to a node, but the node should know how to read the database it is pointed to.

Workflow data models are created to keep data exchanges at the workflow level as simple as possible. Workflow data movement is modeled and defined by data links. These only define the data that is used by decisions and as explicit inputs/outputs associated with nodes. Large, commonly used tables shared between applications for common storage are not included, since each node knows what tables it needs and how to read from each table. An example of a data link is the result of a similarity search engine query represented as an output from an SSE Node, serving as input to another node. The similarity search engine uses the source of the query itself to produce its result, such as the list of documents in the source database. Only the result is passed to the next node, not the entire set of database documents.

The process flow model defines paths to follow. While simple processes define a single path of execution, processes may allow for parallel, concurrent paths of execution. Process splitting and joining is used to break a process into concurrent parallel paths and to merge separate paths back into a single path.

The splitting, or forking, of a process flow is breaking a process into two or more parallel and concurrently executing processes that each process independently of each other. Each path follows through different flow model components and/or though different sub-processes. Note that process routing is not to be confused with process forking. Routing may have, at its option, multiple paths to proceed through, but it takes only one path of execution, maintaining the single process execution throughout. Process forking on the other hand results in multiple parts of a process being performed at the same time, along different parallel paths. As a result, the original process may either cease to exist or exist as one of the forks; the process model may indicate a specific path for the primary process to follow, if any. A process fork is the spawning of parallel, concurrent processes of single or multiple artifacts along the same process flow. In addition, where node groups are used, allocating a task or tasks to different nodes within the group is not considered process forking. Forking can occur two different ways. First is the use of flow control nodes, which support process forking and joining. Second is from within decision objects. Decisions evaluate data and determine one or more subsequent processing paths.

Process flow joins are the merging of previously split processes into a single process. Flow control nodes are the only model component that supports process joining. The node may specify if all inputs are required before a join, or if that decision is left up to the input control links. Control links define what sub-processes get joined in a flow control node. The joining of separate paths raises some issues. First is the fact that processing execution from different paths will likely arrive at a join at different times. The join decides how to handle this condition, whether to wait for all paths to arrive before continuing, wait for certain paths, or do not wait at all. Since separate paths may produce data that is used elsewhere in the process, care must be exercised when defining a join. Another issue is the possibility of dead paths. A dead path is an execution path that never completes. While properly defined process flows account for all conditions that may result in a dead path, a node that does not respond and does not timeout could cause a dead path condition to occur. Dead paths become an issue when a join is waiting on processing to complete for the path, but process execution never reaches the join because that path will not complete. The result is that the complete process ‘hangs’ and becomes a dead path itself. Care must be taken to ensure that no dead paths can occur.

Data can be split or joined by passing data sets through a data splitter node. Data splitting, or forking, is the process of separating a data set containing XML documents into multiple data sets, each consisting of a single XML document, and then running each document through the same workflow process in parallel sub-processes. Typical use is to obtain a list of datathen process each one through the same process flow, letting each one navigate through the process as its data dictates.

Data joining is the process of combining data split sub-processes into a single process. A data joiner component provides the data join operation. A data joiner references the data splitter which split the data. The data joiner waits for all split processes to complete before continuing. Similar to process flow joins, data joins run the risk of timing and synchronization problems. Since all split sub-processes must arrive at the join, if any of the processes fails unexpectedly and the error is not properly handled, that sub-process thread will not reach the data joiner, causing the process to hang at the data joiner. As in flow joining, care must be taken to ensure that no dead paths can occur. Care must also be taken to prevent too many sub-processes from being spawned at one time. An excessive number of sub-process threads can severely impact a server's performance. To prevent thread resource allocation problems, thread pooling techniques are used to allocate processing threads for each spawned sub-process.

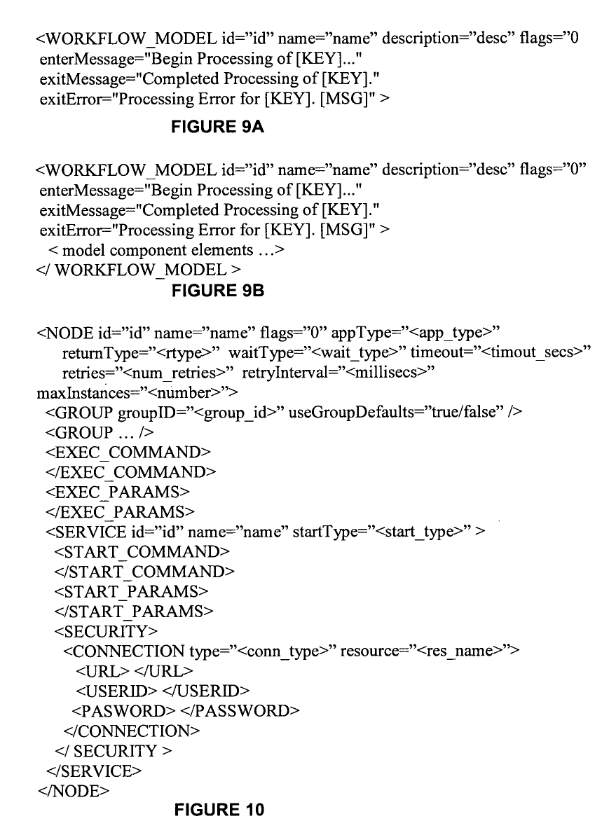

Turning to FIG. 9A, FIG. 9A shows a partial WORKFLOW_MODEL definition to illustrate common attributes that may be defined in any component. Each workflow model's definition is contained in a single XML model file. The root element is the WORKFLOW_MODEL. All process and data components are defined as child elements therein. Attributes are defined as name value pairs, where the attribute name identifies the attribute, and the value is defined within quotation marks. The WORKFLOW_MODEL definition shown in FIG. 9A is used to show the common attributes that can be defined in any component. All attributes except for description are common to all components.

The following are common attributes that can be defined in every component. Attributes for ID and name are required on every component. ID and name values must be unique within a model. The ID and name is used to unique identify the component within a model. ID is a numerical value, while name is usually a descriptive name. Workflow can provide feedback messages for status and progress. It is sometimes desirable to see specific messages when entering or exiting a component, as well as when starting or ending an entire model. Three status message attributes exist for providing such informational messages. These are:

enterMessage—displays this message when the process enters the component;

exitMessage—displays this message when the process completes and leaves the component; and

exitError—displays this message when the process leaves the component with an error.

Values enclosed within in brackets represent placeholders for runtime values that are provided by workflow. For example, [KEY] is the document being processed primary key. Many components support a flags attribute. This is used to define numeric flag values for special purposes and control. Each component defines its interpretation of flag values.

Turning to FIG. 9B, FIG. 9B shows a WORKFLOW_MODEL definition that includes model component elements. Attributes ID and name uniquely identify the model amongst all the models. The name and ID must be unique. The description attribute is an optional text description, usually for the author's comments.

Turning to FIG. 10, FIG. 10 shows a NODE definition. A node is a service or application that provides some process transaction. Node definitions separate node-specific values from generic “service” level values. Services are separated so that in future system implementations, the location of the service may be defined and managed by other systems. Nodes use specific services to do their task. Therefore, node-related values are defined at the node level, while service-specific values are defined at the service level. Node-level attributes consist of the following:

appType—Node application type; several types are allowed. 1=XCF Command Server interface; 3=java class in a local package; 4=standalone executable program, such as an exe, bat, or script file; 5=HTTP URL (Web service); 10=internal workflow utility class;

returnType—node return or result type. 0=no explicit return type, but if a string is returned, the result is a simple string; 1=XML result string; 2=return code;

waitType—how control is to wait for the node; values are: 2=“wait” (synchronous call); 1=“nowait” (asynchronous call); 4=“timeout” (wait for specific number of seconds, then timeout with an error);

timeout—if waitType is “timeout”, this is how many seconds to wait for it to timeout

retries—if the node cannot be started or executed, this is the number of times to retry. The default is 0 for no retries;

retryinterval—if retries is specified, this is the number of milliseconds to wait between retries. If 0, retries right away without waiting; otherwise waits this many milliseconds between attempts; and

maxinstances—the maximum number of concurrent executions of this node allowed, with 0 being unlimited. This is used to limit the node so to prevent it from being overloaded with too many simultaneous requests.

Regarding FIG. 10, the GROUP sections define the Node Groups the Node belongs to and how each group's values are to be used by the node. A separate GROUP section exists for each group the node belongs to. Attribute groupID defines the ID of the Node Group. Attribute useGroupDefaults is “true” if the node is to use any defined values in the group for its default values; this would be “false” if a node had empty values that should not be provided by the group as defaults. EAEC_COMMAND is the command used to execute the node's services, typically as a request. This executes a specific command. For XML command nodes, this would be the XML command to execute; connection to the XML command server/service is as defined below. In addition, EXEC_COMMAND is used to define the call to a one-time command provider, such as an .exe or .bat. EAEC_PARAMS are any parameters used when executing the node. Service level definitions contain the following. These apply to the service provider that the node uses to perform its actions. Attributes id and name are the same as the node, and are used here for future compatibility. Attribute startType defines how the service is to be initially started, if workflow must start it before using it. START_COMMAND is the command used to startup the node when the node is a stand-alone service that must be started before being executed; this is not to be used to call a program such as an .exe for a one-time command. This starts the service so that ‘execute’ commands can be issued to the service. START PARAMS are any parameters used when starting the node; see “Node Parameters” below for parameter usage.

COANECTION defines how to connect to the service. The type defines the connection type, as “connection”, “datasource”, etc. The resource, if given, is the name of the object for the connection. This can be an Similarity Search Engine data value, such as a “datasource”. If so, the contents for the connection are obtained from a Data Set with the datasource data; the data set values provide default values but do not override explicit values defined in the node. For example, if the URL is defined in the node but no ID nor password is defined, the datasource data would provide the ID and password values. Another possible set of values is for a Command Connector. The implementing class is identified in resource, and the XML within the <CONNECTION> section defines the configuration string to call on the implementing class. The simplest set of values is for a Connection Bean; the type identifies it as such, and the XML contains the URL, userid, and password values.

Node parameters are defined within the EAEC_PARAMS element. The parameter, if used, is specific to the node and typically includes data and values to pass in to the node. Some nodes internally handle their input parameters as an array of strings, while others may take a single string as the entire input. When a node application type is used for “java class” or “executable”, the input parameters are separated into individual values, separated by spaces. The set of values is then passed into the node as an array of strings, the typical calling convention for C and Java programs. Some parameters may need to define values that represent a string, with imbedded space characters within the string. To define such a string as a single parameter, enclose the string with double curly braces on both ends ({{and }}). For example a Fraud Alert Task Assigner accepts the following inputs:

-runid [RUNID]-sourceds{{[DATASOURCEDEFAULT]}}

-targetds{{[DATASOURCEDEFAULT]}}

The datasource strings consist of XML definitions, which themselves contain spaces and quote characters. By encasing the datasource definitions into strings with {{and }}, workflow can parse the input, but the proper array of strings, and call the node with its expected parameters. The [DATASOURCEDEFAULT] tells workflow to use its own datasource, where workflow data is stored, as the datasource XML to plug into the parameter string.

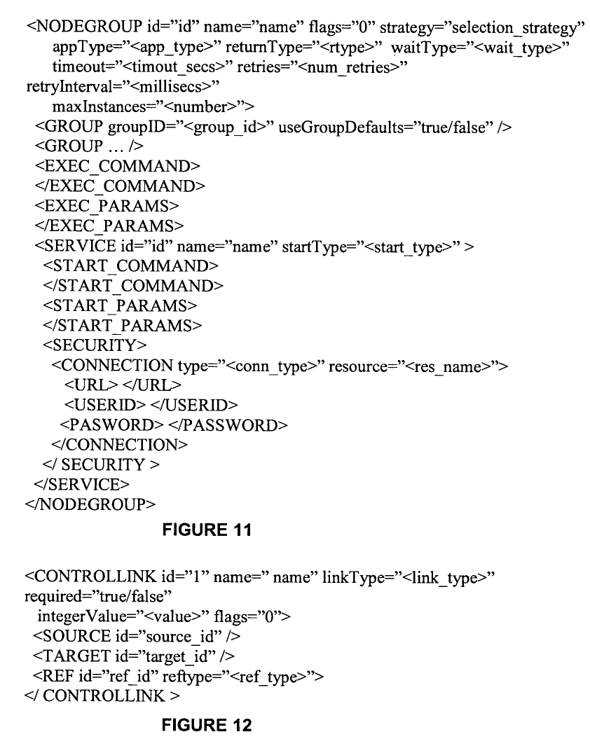

Turning to FIG. 11, FIG. 11 shows a NODEGROUP definition. Node groups extend the definition of nodes to provide a non-specific node component in the process model. Actual available nodes are either managed by the group or accessed by the group as remote services. The configuration definition is very similar to that of nodes, in that default values can be defined for the entire group. Specific node invocation settings, however, are not included, since the group itself does not store its nodes within the configuration information. Attribute strategy is used to define the node selection strategy. Specific implementations can be specified. All other values are as described under nodes. Values that exist in a node group provide default values for values that do not exist in a Node. In addition, a node group may exist in another node group.

Turning to FIG. 12, FIG. 12 shows a CONTROLLINK definition. Control links connect components to each other in the process flow portion of a workflow model. Flow is from the source to the target. The SOURCE defines the component that process flow is coming from, and TARGET defines the component that is next in the process. Control link attribute linkType defines, in most cases, the type of component that is pointed to by the source. Possible values are: 2=node or node group; 3=decision; 4=another control link; 5=data link; 6=data transformation, and 7=flow control node. Two special linkType values are used to identify the starting and ending points in a process. A value of 1 indicates the start of a process, ignoring the target component. A value of 9 indicates the end of a process path. In a process model, this is the proper way to indicate the end of a process. A control link can be identified as the default path by specifying a hex value of 8 in the flags attribute. Where multiple control links leave a component, this tells the system which link points to the default process path. Attribute required applies to points of process flow joins, when two or more paths converge into a flow control node; this does not apply to single-threaded processes. A value of true indicates that the process flow must complete through this control link for subsequent processing to continue, while a value of false indicates that the workflow should not wait for the control link to complete. A value of true would be used when all paths must complete before moving on, while a false value would allow continuation of the main process path whenever any process has reached that point from any control link. Attribute integerValue is an optional integer value associated with the control link. The SOURCE defines the component that process flow is coming from, and the id is the ID of the source component. For control links of linkType 1, the source ID is 0. TARGET defines the component that is next in the process, and the id is the ID of the target or next component. For control links of linkType 9, the target ID MUST BE 0. REF values define an optional additional object reference for the link. The id is the ID of another component. The reftype is the type of object referred to in the ID, and it has the same values as linkType, excluding 1 and 9.

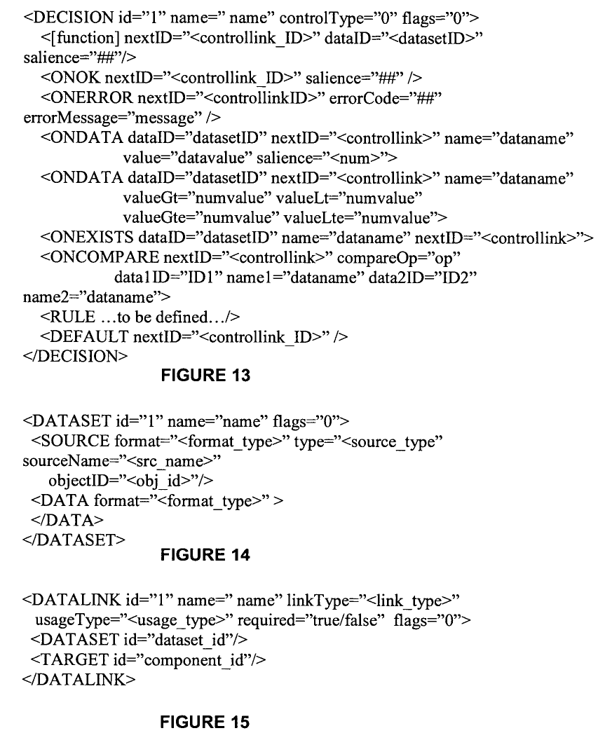

Turning to FIG. 13, FIG. 13 shows a DECISION definition. Decisions are used to alter process routing based on specific conditions. Attribute controlType is the style of decision control, where 0 means “single”, which supports one process routing choice, taking that path as soon as the decision finds that path. Value 2 means “multiple”, supporting multiple process paths, where each valid path is branched as a separate sub-process path for each valid evaluation. Value 2 means “multipleWithDefault”, which causes flow to occur on any matching path, each in their own sub-process, in addition to always taking the default path. Next are keywords and predefined condition evaluation functions. Each must contain a nextID, which is the ID of the Control Link to flow to upon successful evaluation of the condition. The source of the data for the function can be defined by dataID, which is the ID of a specific Data Set; if not provided, any Data Set or available object will be used to find the data. In addition, each function has an optional salience value, which defines the priority of processing of the condition. Priority goes to the highest value first. If no salience is given, 0 is assumed. Values can be positive or negative. Specific functions contain specific definitions as described below.

ONOK—matches when the return code (RC or rc) is 0; used as a result of node actions.

ONERROR—matches when an error is produced. If errorCode or errorMessage is specified, the function looks for a specific error condition. Otherwise, all errors are routed to the link defined for this function.

ONDATA—evaluates a data set data item with a specific value. The data item is named by its name, and the value to compare with is defined in value. The dataID should be provided so that the specific data set can be obtained; however, if dataID is not provided, the name is searched for in all available data (data sets) to the Decision. Either an exact data value can be used or a range of numerical values can be used as the source of data. If a specific string or numerical value is needed, use value to specify the required value. For numerical ranges, several definitions are available. A ‘greater than or equal’ comparison is defined by valueGte; the value is the minimum allowed value, inclusive. For a ‘greater than’ value, use valueGt. A ‘less than or equal’ comparison is defined by valueLte; the value is the maximum allowed value, inclusive. For a ‘less than’ value, use valueLt. For example valueGte=“0.5” valueLt=“1.0” requires the value to be 0.5<=x<1.0; valueGt=“2.45” means the value must be above 2.45. (Note: for exact comparison of a value, use the “value” attribute.)

ONEXISTS—checks to see if data exists for the given name. A value, as a string, must exist for the name for this to evaluate to true. Numerical values are treated as strings, such that 0 is “0”, in which case a value exists. Only empty or null strings cause this function to evaluate to false.

ONCOMPARE—compares two values. The values can be strings or numbers. The default is a string compare; if both values are present and are both numbers, a numeric compare is done instead. Two values are used for the comparison. The first value is obtained from a data set using data1ID as the data set ID and name1 as the value name. The second value is obtained from a data set with an ID of data2ID with a name of name2. Both data1ID and data2ID can be the same value to get two values from the same data set; if both are 0, gets values from the current data sets wherever the name exists.

The comparison operation, compareOp, is one of the 6 standard comparison operations: <, <=, =, < >,>, and >=. This compares value1 to value2, per the compareOp operation, returning true if the operation is true. String comparisons are not case sensitive; “Hello” is =to “HELLO”. Note that less than and greater than comparisons should only be used on numerical values; while two strings can be compared this way, the result is unsupported and may be unpredictable. (Note: to use <,<=,>, or >=, the workflow models use “&It;” in place of the “<” symbol and “&gt;” in place of the “>” symbol to prevent XML parsing errors.)

DEFAULT—must be defined; this defines the default routing if all other functions do not evaluate to true.

RULE—specific rule evaluation.

Turning to FIG. 14, FIG. 14 shows a DATASET definition. A data set configuration contains the data set identification and the source of the data, along with any constant or pre-defined values. Data can be constant values or be obtained during workflow processing. SOURCE identifies the source of the data, and the type explicitly defines where the data comes from. Attributes sourceName and objectID are used to further define source characteristics, dependent on each type value. Table 2 describes the various types and related values.

TABLE 2

| Type | Description | Additional Attributes |
|---|---|---|
| 1 = process | Data is derived within the process, | none |
| | typically built by Data | |
| | Transformations or from internal | |
| | processing actions | |
| 2 = node | Data is the output of a Node, Node | none (a Data Link links the |
| | Group, or Data Transformation | Data Set to the specific node) |
| 5 = schema | Data is obtained via a Document Read | sourceName - defines the name |
| | using the given schema | of the schema |
| 6 = database | Data comes from a database | sourceName - name of an SSE |
| | | datasource to get the data from, |
| | | or the XML defining the |
| | | datasource configuration to use |
| | | to connect to the database |
| 8 = validator | Data contains constant values, used as | none |
| | an XML schema map to identify | |
| | required data values for validation | |
| | functions. | |
| 9 = constant | Constant data values | none |

The source format attribute defines the format of the data in the source. The format can be 0 for raw string data, or 2 for XML-structured data; the default is raw. In addition, if the data set contains a collection of multiple values as a variant list, the hex value 0x10 must be added to the format value. This tells the data set and other workflow functions that the data consists of a list of values or ‘objects’ instead of a single instance. The DATA section contains the definition of the data structure expected, unless if the type is a schema, in which case the schema defines the data structure. The format attribute in DATA defines the format of the data in the DATA section. The format can be 0 for raw string data, or 2 for XML-structured data; the default is raw. Raw data does not get parsed into individual data values, while XML data does. Individual data values can be extracted by other workflow components, such as Decisions. Whenever practical, format type 2 (XML) is used.

Turning to FIG. 15, FIG. 15 shows a DATALINK definition. A data link associates a component with a data set. Components either use the values in a data set or provide data that is stored into a data set. A component providing values INTO a data set is a ‘data source’, while a component using the values in a data set is a ‘data sink’. Attributes linkType and usagetype define how a data set is interfaced by a component. The linkType defines how a Data Set is linked to the component. This typically includes the type of component linked with and an indication of data source and/or data sink usage (a component can be both a source and a sink). Possible linkType values are:

2=with a node, as either input or output data or both.

3=to a decision as input data.

4=to a control link as input data to the control link's target component.

7=to a flow control node for input data.

12=with a data transformation as an input, output, or both.

To indicate usage as a ‘data source’ or an input to a data set, add the hex value 0x10 to the linkType. This indicates a logical flow of data “into” the data set. To indicate usage as a ‘data sink’ or as a user of data set data, add the hex value 0×20 to the linkType. This indicates a logical flow of data “out of” the data set. Both values can be included if the component uses the data set as a source and a sink; however, typically different data links would be used to define each connection for simplicity. The usageType defines how a component uses the data. Values may be:

1=the data represents a command or execution string for a node.

2=the data is used and input parameter data to a node or other component.

4=the data represents a node's output data

5=the data is the output data from a data transformation

0=node of the above; if this is the case, then one of the flag values below must be used.

In addition to these values, several flag values may be added to further define usage. Add the appropriate value to the usageType value.

0x10 (or 16)—the component is a ‘data source’ or provider of data.

0x20 (or 32)—the component is a ‘data sink’ or user of the data.

0x80 (or 128)—miscellaneous usage; must be used if no other type is specified

0x100 (or 256)—input parameter that is imbedded in the definition of another input parameter; this Data Set's data is plugged into the [PARAMS] tag in any other input parameter data (likely from another Data Set) that serves as input to a Node.

0x200 (or 512)—additional input parameters; combine internally with other input parameters to provide a single set of input parameters for a node

LinkType is a link usage type value.

param—input parameter

output—output from the component

data—unspecified data usage

datasource—link identifies the input to a data set from a data source

datasink—link identifies an output for the data set

Attribute required is used to indicate if the data is required before process flow can continue. If this is set to true, then workflow checks for the presence of data in the data set and proceeds to load the data if not present, depending on the data set source. This setting applies when multiple data links are used as inputs to a component and to make sure data is present before proceeding. A value of false tells workflow that the data is not required and to proceed without it if data is not present. DATASET identifies the data set this links with; the id is the ID of the data set. TARGET is the component the data set is linked with; id is the ID of the component.

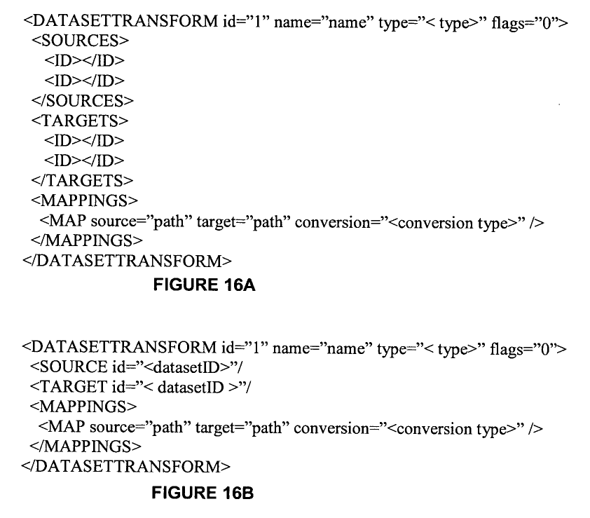

Turning to FIGS. 16A and 16B, FIGS. 16A and 16B show DATASETTRANSFORM definitions. Data transformations are special nodes that combine or split one or more input data sets into one or more output data sets. The sources are the data sets providing input data, and targets are the data sets receiving the results. The same data set can exist on the source and target. Data links must be used to link the data transformation to the data sets it uses. This is required, even though the explicit data set IDs are defined in the data transformation, because the data link defines how each data set is to be used. FIG. 16A depicts format definitions for multiple sources and multiple targets. FIG. 16B depicts format definitions for a single source and target. Not shown are the cases of a single source and multiple targets and multiple sources with a single target. Both of these variations are allowed. Single source with multiple targets would have a SOURCE element with a TARGETS group. Multiple sources with a single target would have a SOURCES group with a TARGET element. Attribute type defines the type of transformation to take place. A value of 1 indicates to use the normal, default transformation of specific mapped elements in the specified sources and targets. Additional types may be defined in the future. SOURCE identifies a single source data set for the data transformation. The id is the ID of a data set in the model. If more than one source is needed, used SOURCES instead of SOURCE. SOURCES list the IDs of multiple sources, where each ID element is the ID of a data set. SOURCE and SOURCES may not be used at the same time in a data transformation definition; use one or the other, but not both. TARGET identifies a single target data set for the data transformation. The id is the ID of a data set in the model. If more than one target is needed, used TARGETS instead of TARGET. TARGETS list the IDs of multiple targets, where each ID element is the ID of a Data Set. TARGET and TARGETS may not be used at the same time in a data transformation definition; use one or the other, but not both.

Data transformations use XML element and attribute mappings to map a specific value from a source data set to an element or attribute in a target data set. The MAPPINGS section defines the specific mappings. Elements may consist of any valid XML element, including containing attributes and sub-elements. When such a compound element is copied from a data set, its entire structure is copied to the target data set. Each MAP entry defines a specific source and target. The source is the source of the data, either as a specific XML path in the Data Set or as a predefined internal function. The target is the XML path that is to receive the value. If the source path has no data, nothing is copied in the target; any existing data in the target remains unchanged. If the source path has data, any existing data in the target is overwritten.

The conversion attribute defines any special conversion operations that are to take place during the mapping. Typically, this is needed to convert from one format of data in the source to another in the target, such as a long time value to a fully formatted timestamp string. The valid conversion values are:

none—no conversion is done; direct copying is performed;

list—the source data is a list of elements with the same element name, where a list or group of elements is produced in the target;

listtostring—converts the elements and data in the source list to a single string value; and

timestamp—the source value is converted to a timestamp format.

In addition to XML paths, the source can define internal workflow functions, typically used to get specific values or to perform custom calculations and conversions. The format of such functions is two semicolons followed by the function name. For example: <MAP source=“::currenttime” target=“MTDOC/MYDATE” conversion=“timestamp”/>the source is a the workflow's currenttime function. The supported functions are:

currenttime—gets the current system time for time stamping needs.

Some other examples of mappings are:

<MAP source=“DOCUMENT/NAME” target=“NAME” conversion=“none”/>

<MAP source=“DOCUMENT/ADDRESSES” target=“PAST_ADDRESSES” conversion=“list”/>

<MAP source=“::currenttime” target=“MYDOC/MYDATE” conversion=“timestamp”/>

The first map copies data from the DOCUMENT/NAME xpath in the source data set to the NAME xpath in the target data set. The second copies the list of addresses in path DOCUMENT/ADDRESSES in the source to the PAST_ADDRESSES element in the target. The last one gets the current system time, converts it to a timestamp value, and stores it in the MYDOC/MYDATE element in the target.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A software implemented method in a computer system for controlling and monitoring a workflow process by arranging complex tasks into predefined sequences according to the workflow process, the method comprising the steps of:
defining procedural components of a process flow model;
defining control links for connecting the procedural components of the process flow model;
defining data components of a process data model;
defining data links for connecting the procedural components of the process flow model and the data components of the process data model; and
invoking the procedural components for producing a workflow process result.

2. The method of claim 1, wherein the step of defining procedural components of a process flow model comprises the steps of:
specifying nodes for identifying automated applications, services, function process steps and manual process steps of the workflow process;
specifying node groups for containing multiple active nodes;
specifying decision nodes for evaluating data and making flow control routing decisions in the workflow process; and
specifying data transformations for inputting one or more data sets and for outputting one or more data sets; and
specifying flow control nodes for splitting one process path into multiple process subpaths and joining multiple process subpaths into a single process path in the workflow process.

3. The method of claim 2, wherein the manual process steps comprise interactive nodes.

4. The method of claim of claim 1, wherein the step of invoking the procedural components comprises the steps of:
initializing node processing and setting node counter N=0;
invoking node N and updating node status;
performing node N processing;
updating node N process table;
obtaining node N output data;
evaluating node N results by decisions and rules;
determining if all nodes are invoked;
if all nodes are not invoked, letting N=N+1 and repeating the steps above beginning at the step of invoking; and
if all nodes are invoked, ending the method.

5. The method of claim 1, wherein the step of defining data components of a process data model comprises the steps of:
specifying data sets and data with a format specification;
specifying a source of the data; and

6. The method of claim 5, wherein the step of specifying data sets comprises the steps of:
specifying input data;
specifying output data;
specifying a processing node.

7. The method of claim 1, further comprising defining the workflow process, the procedural components, the control links, the data components and the data links as XML files.

8. The method of claim 1, further comprising the step of storing the process flow model, the control links, the process data model and the data links in a workflow database as workflow process configuration tables.

9. The method of claim 1, further comprising the step of defining the workflow process as a root element, comprising the steps of:
specifying unique identification and name attributes of a workflow process;
specifying message attributes including enter process message, exit process message and exit error message;
specifying an optional description of the workflow process; and
specifying workflow process child component elements.

10. The method of claim 2, further comprising the step of specifying nodes as child component elements, comprising the steps of:
designating unique identification and name attributes of a node component;
designating node attributes, including application type, return type, wait type, timeout, number of retries, interval between retries, and maximum number of concurrent executions;
designating a node group that the node belongs to;
designating a command for executing the nodes services and any parameters used when executing the node;
designating service level definitions including identification, name and start type;
designating start command and associated parameters; and
designating security parameters including connection type and resource, URL, user identification and password.

11. The method of claim 2, further comprising the step of specifying node groups as child component elements, comprising the steps of:
designating unique identification and name attributes of a node group component;
designating node group attributes, including application type, return type, wait type, timeout, number of retries, interval between retries, and maximum number of concurrent executions;
designating a node group strategy attribute for determining a node selection strategy;
designating a node group that the node group component belongs to;
designating a command for executing the nodes services and any parameters used when executing the node;
designating service definitions including identification, name and start type;
designating start command and associated parameters; and
designating security parameters including connection type and resource, URL, user identification and password.

12. The method of claim 1, further comprising the step of defining control links as child component elements, comprising the steps of:
designating unique identification and name attributes of a control link component;
designating control link attributes, including link type for defining the type of component that is pointed to by the source, required for designating process flow joins, and optional integer value for defining the control link;
designating a source identification for defining a component where a process flow is coming from;
designating a target identification for defining a component where a process flow is going to; and
designating a reference identification for an optional object reference for the control link.

13. The method of claim 2, further comprising the step of specifying decision nodes as child component elements, comprising the steps of:
designating unique identification and name attributes of a decision node component;
designating decision node attributes, including decision node control type for indicating support for single or multiple control paths, condition evaluation functions for directing control path upon successful evaluation of the condition, data identification for indicating a source of a specific data set, and an optional salience value for determining a priority of processing of the condition;
designating an onok when a return code is 0, an onerror function when an error is produced, an ondata function when evaluating a data item with a specific value, an onexists function for checking to see if data exists for a given name, and an oncompare function for comparing two values that may be strings or numbers; and
designating a rule function for specific rule evaluation and a default function for defining default routing.

14. The method of claim 5, further comprising the step of specifying data sets as child component elements, comprising the steps of:
designating unique identification and name attributes of a data set component;
designating data set attributes, including source identifiers for identifying a source of data, type for explicitly defining where the data comes from, source name and object identification for defining source characteristics; and
designating a data format definition for defining a format of the data in the source and a data attribute for defining an expected data structure.

15. The method of claim 1, further comprising the step of defining data links as child component elements, comprising the steps of:
designating unique identification and name attributes of a data link component;
designating data link attributes, including link type for defining how a data set is linked to a component, usage type for indicating if a component is a source or sink for data, and required for indicating if data is required before process flow can continue; and
designating data set identification for containing data, and target identification for identifying a component for linking to the data set.

16. The method of claim 5, further comprising the step of specifying data transformations as child component elements, comprising the steps of:
designating unique identification and name attributes of a data transformation component, and type for defining a type of data transformation; and
designating data transformation elements, including sources for identifying data set sources for the data transformation, data set targets for identifying target data sets for the data transformation, and mappings for mapping a specific value from a source data set to an element in a target data set.

17. A computer-readable medium containing instructions for controlling a computer system according to the method of claim 1.

18. A software implemented system in a computer for controlling and monitoring a workflow process by arranging complex tasks into predefined sequences according to the workflow process, the system comprising:
means for defining procedural components of a process flow model;
means for defining control links for connecting the procedural components of the process flow model;
means for defining data components of a process data model;
means for defining data links for connecting the procedural components of the process flow model and the data components of the process data model; and
means for invoking the procedural components for producing a workflow process result.

19. The system of claim 18, wherein the means for defining procedural components of a process flow model comprises:
nodes for identifying automated applications, services, function process steps and manual process steps of the workflow process;
node groups for containing multiple active nodes;
decision nodes for evaluating data and making flow control routing decisions in the workflow process; and
data transformations for inputting one or more data sets and for outputting one or more data sets; and
flow control nodes for splitting one process path into multiple process subpaths and joining multiple process subpaths into a single process path in the workflow process.

20. The system of claim 18, wherein the means for defining data components of a process data model comprises:
data sets and data with a format specification;
a source of the data.

21. The system of claim 18, wherein the means for defining control links comprises a designation of a source component for defining where process flow is coming from, and a designation of a target component for defining where a process flow is going to.

22. The system of claim 18, wherein the means for defining data links comprises a designation of a data set as a source and sink for data, and a designation of a target component for linking to the data set.

23. The system of claim 18, wherein the means for invoking the procedural components comprises a workflow manager and a workflow database.

24. The system of claim 18, further comprising custom application nodes, server application nodes and user application nodes.

25. A software implemented system in a computer for controlling and monitoring a workflow process comprising;
one or more workflow managers for controlling and invoking procedural components of the workflow process;
a workflow database connected to the one or more workflow managers for persisting workflow process tables and configuration tables, including nodes, decisions, control links, data sets and data links;
the procedural components of the workflow process including nodes, node groups, decision nodes and flow control nodes; and
the procedural component nodes including workflow user applications, automated applications, services, function process steps and manual process steps.

26. The system of claim 25, wherein the one or more workflow managers and the procedural components are interconnected by a dynamic services network, whereby the one or more workflow managers make requests for procedural component execution via a network queue controlled by a workflow monitor/administrator.
